(19) United States
(12) Patent Application Publication
(10) Pub. No.: US 2016/0010774 A1
(43) Pub. Date: Jan. 14, 2016

(54) Nipple with flanged end to couple urinal to waste line

(71) Applicant: Thomas Davidson, Hesperia, CA (US)

(72) Inventor: Thomas Davidson, Hesperia, CA (US)

(21) Appl. No.: 14/795,890

(22) Filed: Jul. 10, 2015

Related U.S. Application Data
(60) Provisional application No. 62/022,666, filed on Jul. 10, 2014.

(51) Int. Cl. F16L 23/02; F16L 15/00; F16L 23/18

(52) U.S. Cl. CPC F16L 23/02; F16L 23/18; F16L 15/00

(57) ABSTRACT

A plumbing device for coupling a urinal to a soil pipe is provided. The device includes a nipple portion defining a first opening configured to be in fluid communication with the urinal and a second opening configured to be in fluid communication with a “T” receptor on a waste line. The nipple portion further having straight male threading of a pitch that is slightly less than the pitch of the “T” receptor's threading so that as the device is rotated into the “T” receptor a watertight seal is formed. Finally as the nipple portion has no tapered threading it may be cut at any point along its length. The device also includes a flanged portion proximate to and about the first opening configured to receive a resilient gasket on its surface to provide a watertight seal with a urinal and with arms extending radially from the center of the flanged portion containing a structure to receive the urinal mounting bolts.

### CROSS-REFERENCE TO RELATED APPLICATIONS

This application claims priority from U.S. Provisional Patent Application No. 62/022,666 filed on Jul. 10, 2014. The entire disclosure e prior application is considered to be part of the disclosure of the accompanying application and is hereby incorporated by reference.

### BACKGROUND OF THE INVENTION

1. Field of the Invention

The present invention relates generally to the field of plumbing couplers. More specifically, the present invention relates to plumbing couplers for coupling a urinal to a building's waste line.

2. Description of the Prior Art

Presently the two key plumbing couplers used to couple a urinal to a building's waste line are a flange, at times also called a bracket, and a nipple. The flange is used to secure the urinal to the wall while at the same time provide a substantially watertight seal for urinal effluent to pass through the flange and into the nipple. Nipple is a term of art used by plumbers to label a short piece of pipe that is installed between couplings or other fittings. When installing a urinal a nipple is used to couple the flange to the building's waste line. The flange, nipple, and waste line all use tapered threads and when properly assembled each connection forms a watertight seal. However the distance between the flange and a building's waste line is not uniform and as a result the length of the nipple varies from one urinal to another. This fact not only prevents a plumber from using a standard size nipple throughout a building but the tapered threading present on the nipple compounds the problem by preventing the plumber from simply trimming the ends of the nipple for a proper fit. At this point a plumber has three options.

The first option is to custom fabricate a nipple on the premises by utilizing a pipe threading machine with measurements taken on site. Such a machine may be electrically or manually powered. Electrically powered pipe threading machines require that an electrical power source be readily available which may be a difficult proposition in construction sites. On the other hand cutting threads manually on many nipples will tax the strength of the plumber. In addition both types of machines are expensive, particularly the electrical pipe threading machines. Finally such a process is time consuming, requiring 30 to 60 minutes, as the plumber must find the proper piping material, cut it down to size, configuring the pipe threading machine, and then cutting the thread on both ends.

A second option is to custom fabricate a nipple by using an appropriate section of pipe and appropriately sized and threaded sweat rings that may be slide over each end of the pipe. Sweat rings are rings that have a smooth inner surface and a threaded outer surface. Once the sweat rings are in place they are soldered to the pipe. After the assembly has cooled it may be used as a nipple. Although this option does not require an expensive pipe threading machine or any electrical power it is a multistep process, the plumber must apply the solder using a high heat source with patience and skill, and finally the assembly must be given time to cool prior to installation.

The third and final option will be to carefully measure the length of each nipple, mark its location, and place an order to have the nipple fabricated. There are some advantages to this approach as there is no need to have a reliable source of electrical power, purchase and maintain expensive pipe threading machines, use flammable fuels, or specialized soldering skills. However the great disadvantage is the number of days that must pass before the order is fulfilled. Other disadvantages include the cost of employee overhead involved with the negotiation, ordering, purchasing, and delivery of the nipples.

Regardless of which option is selected once the nipple is available the plumber must join the nipple to the waste line by screwing one end of the nipple into a “T” receptor on the waste line and then screwing the flange to be used to mount the urinal at the opposite end of the nipple. These two operations take additional time to perform and if not performed correctly leaks may form at either end of the nipple with expensive repairs to result.

To summarize; the prior art plumbing couplers to couple a urinal to a waste line perform that task adequately. The male tapered threading on the end of the nipple that screws into corresponding female tapered threading on a “T” receptor on the waste line provide a watertight seal. The tapered threading on the end of the nipple that screws into a corresponding tapered threaded receptor in the urinal flange also provides a watertight seal. However the process of fabricating a properly sized nipple is time consuming and may require specialized machinery or soldering skills not available to the plumber. With multiple connections there is an increased chance of leaks forming while assembling the parts together.

What is needed is a male threaded nipple that is flanged at one end, fabricated as a single piece, and with threads that allow for the nipple to be cut at any point along its length while still creating a watertight seal when coupled to a “T” receptor on a waste line. When constructed as a single piece the time required to install the urinal is reduced as compared to the prior art combination of nipple and flange. Additionally when constructed as a single piece there is one less coupling as compared to the prior art combination of nipple and flange and so reducing the risks to leaks. Finally as the nipple may be cut at any point along its length without the need to rethread the nipple by using expensive pipe threading equipment, soldering sweat rings, or awaiting shipment of the required nipples the time to install a urinal is greatly reduced. In short installation will be simplified as there will be fewer couplings to be made and with fewer couplings the risk of leaks forming will be reduced.

### BRIEF SUMMARY OF THE INVENTION

The preferred embodiment of the present invention, henceforth to be named “Flanged Nipple”, is comprised of a nipple with a flange at one end. The Flanged Nipple has a first opening that is to be in fluid communication with a urinal and a second opening that is to be in fluid communication with a “T” receptor in a waste line. About the first opening is a flange comprising a lip about the first opening and two arms extending radially from the center of the first opening. The surface of the lip adjacent to the urinal is configured to receive a resilient gasket. When a urinal is mounted to a Flanged Nipple the urinal's trapway outlet is compressed against the resilient gasket forming a watertight seal. The two arms extending radially from the center of the first opening contains one or more screw holes designed to receive mounting bolts that pass through the urinal and upon tightening the mounting bolts the urinal is compressed against the resilient gasket and attaches the urinal to the Flanged Nipple. Between the first and second opening the Flanged Nipple resembles a nipple but with male threading traversing along the entire length. The male threading is straight threading across the entire length with the thread pitch being slightly less than the thread pitch of the waste line “T” receptor that receives the second opening. In having male threading straight along the entire length the Flanged Nipple may be cut at any point without requiring any additional work on the part of the plumber to rethread or adapt the cut end of the Flanged Nipple to be properly received by the waste line “T” receptor. In having a thread pitch that is slightly less than the thread pitch of the waste line “T” receptor the Flanged Nipple may be screwed a sufficient distance into the waste line “T” receptor yet the slight mismatch between the threading allow for a watertight seal to be formed.

A secondary embodiment to the Flanged Nipple involves a change to the two arms that radiate from the center of the first opening in that the one or more screw holes in each arm that are designed to receive mounting bolts are replaced by a channel that traverses along the entire length of the arm of a width so that mounting bolts that pass through the urinal mate with receiving nuts and washers positioned along the back side of the arm. Upon screwing the mounting bolts the urinal will compress against the resilient gasket and becomes attached to the Flanged Nipple.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

Neither this summary nor the following detailed description defines or limits the invention. The invention is defined by the claims.

### BRIEF DESCRIPTION OF DRAWINGS

The present invention will become more fully understood from the detailed description and accompanying drawings, wherein:

FIG. 1A-B shows the difference between tapered and straight thread as well as an example of the dimension pitch as applied to screw threads.

FIG. 2 shows the extent of the first stage, termed “Underground” in the art, when installing plumbing lines for a urinal in a building.

FIG. 3 shows the extent of the second stage, termed “Top Out” in the art, when installing plumbing lines for a urinal in a building.

FIG. 4 shows the extent of the third stage, termed “Finish” in the art, when installing plumbing lines for a urinal and the urinal itself in a building using prior art plumbing couplers.

FIG. 5 shows the extent of the third stage, termed “Finish” in the art, when installing plumbing lines for a urinal and the urinal itself in a building using the Flanged Nipple plumbing coupler.

FIG. 6 shows a perspective view of the Flanged Nipple.

FIG. 7 shows the front view of the preferred embodiment of the Flanged Nipple.

FIG. 8 shows the front view of an alternative embodiment of the Flanged Nipple.

FIG. 9 shows the Flanged Nipple, resilient gasket, and urinal prior to coupling.

### DETAILED DESCRIPTION OF THE INVENTION

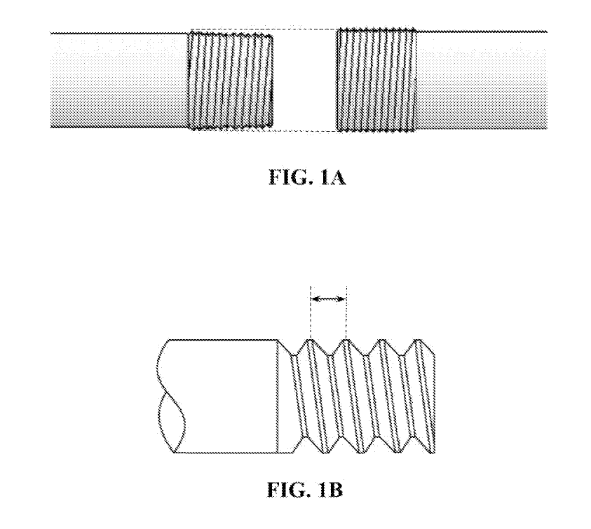

A portion of this disclosure concerns terminology used in the field of plumbing that relates to the thread used on a nipple. The term taper as applied towards thread on a nipple means that the threaded section is slightly conical in that as the threads approach the end of the nipple more material is taken from the nipple so that the outside diameter of the thread at the end of the nipple is smaller than the outside diameter of the thread at the point where the thread originates. According to the American National Standards Institute (ANSI), a private non-profit organization that oversees the development of voluntary consensus standards for products, services, processes, systems, and personnel in the United States, the angle between the taper and the center axis of the pipe is 1.7899° (see ANSI 131.20.1 Pipe Threads, General Purpose). FIG. 1a shows two nipples of the same size end to end with each other with the nipple on the left having tapered threading while the nipple on the right having straight threads. Tapered male threads as shown in FIG. 1a are used with a corresponding plumbing coupler having female tapered threads when the requirements call for a watertight seal. In the prior art, tapered threading is used on a nipple to couple with a flange on one end and at the other end to couple with a waste line “T” receptor. However it is clearly evident that if a nipple's tapered end are trimmed in order to properly bridge the distance between a waste line and a urinal, those ends will no longer provide a watertight seal as they will not be able to travel the required distance into the female receptor that is needed to form a watertight seal. Pitch is the distance from the crest of one thread to an adjacent thread as shown in FIG. 1b. The smaller the pitch the closer the crest of one thread will be to an adjacent thread while a larger pitch will increase the distance from the crest of one thread to an adjacent thread.

When installing plumbing for a building there are three stages to the process. The stages are termed in the art as “Underground”, “Top Out”, and “Finish”.

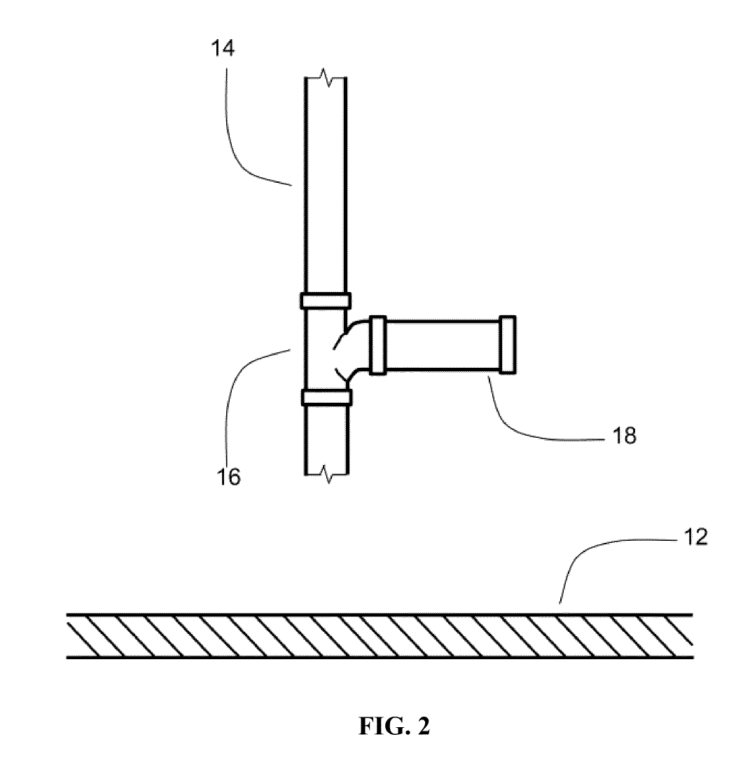

During the Underground stage all of the plumbing that is subsequently covered up in later stages are installed. Portions of the plumbing that provide access points for connection to fixtures such as urinals, toilets, sinks, and the such are sealed on a temporary basis so that the plumbing installation may be pressured tested to ensure that there are no leaks. FIG. 2 shows the plumbing that is installed to carry urinal waste once the Underground stage is completed. Floor 12 is shown along with waste line 14 and “T” fitting 16. Depending upon the type of urinal or the height of the individual what will be using the urinal the position of “T” fitting 16 to floor 12. will vary appropriately. Cap up 18 serves two purposes. The first purpose served by cap up 18 is to seal the opening created by the addition of “T” fitting 16 to waste line 14 in order to conduct pressure testing of the plumbing system and locate leaks and weak joints. The second purpose served by cap up 18 is to protrude beyond the wall once the wall is installed so that the plumber will know the location of “T” fitting 16.

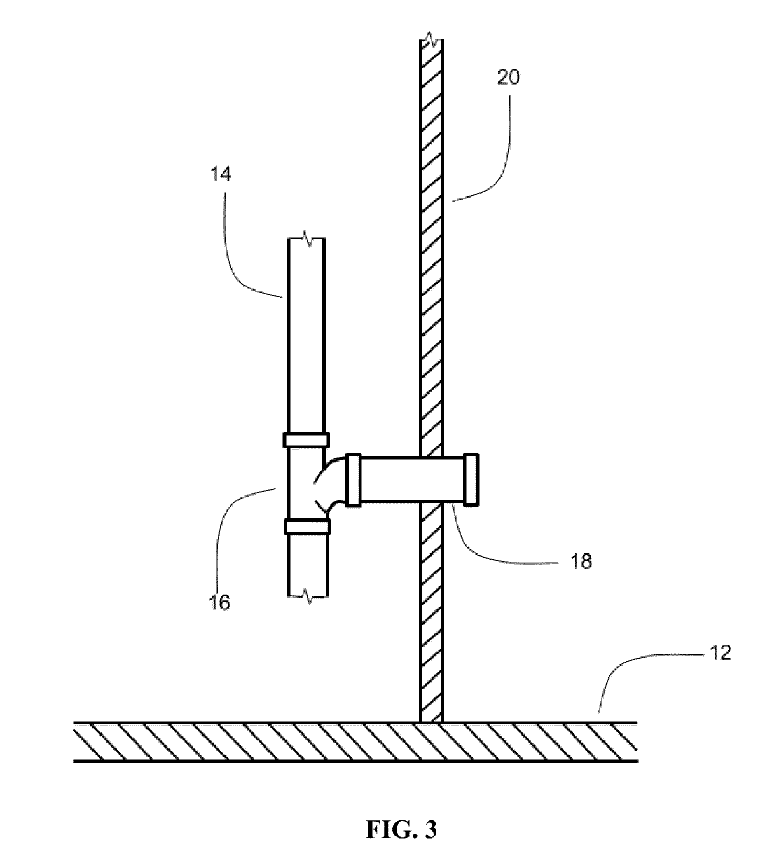

Once the Underground stage is completed plumbing that is to be hidden in the walls or floors are covered up by some sort of finishing material during the Top Out stage. FIG. 3 shows how waste line 14 and “T” fitting 16 is covered up by wall panel 20 and only cap up 18 remains visible as it protrudes from the wall panel. At this point the plumber will mark cap up 18 where it meets wall panel 20 and remove cap up 18. By measuring the distance from the mark made on cap up 18 to the end of cap up 18 that was fitted to “T” fitting 16, the plumber will know how long the nipple is to be made and have the nipple fabricated using one of the three options described in the description of the prior art section given earlier.

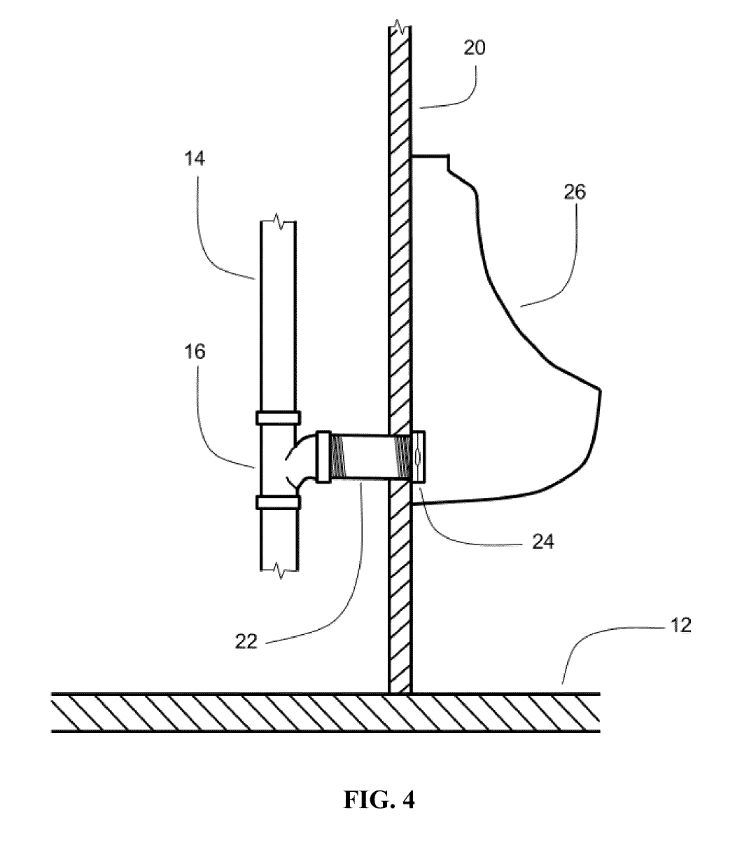

Once the Top Out stage is completed the plumber may initiate the Finish stage where fixtures such as urinals, toilets, sinks and more are connected to the plumbing system. FIG. 4 shows the addition of a urinal to the plumbing system. Once nipple 22 has been fabricated and delivered it may be screwed into fitting 16. As discussed earlier nipple 22 has tapered threads on both ends as shown in FIG. 1a. The tapered threads allows nipple 22 to form a watertight seal with “T” fitting 16 and flange 24 as both “T” fitting 16 and flange 24 contain corresponding female threaded coupling means. Finally urinal 26 may be mounted onto wall panel 20 and connected to flange 24. Not shown in FIG. 4 is resilient gasket that is fitted between flange 24 and urinal 26 in order to form a watertight seal between flange 24 and urinal 26.

As discussed in the description of the prior art section given earlier the fabrication of nipple 22 takes considerable time once cap up 18 is marked and removed to when nipple 22 has been fabricated and is ready to be screwed into “T” fitting 16 and flange 24. In addition it has been discussed that the coupling between nipple 22 and flange 24 may form leaks and requires additional time and effort by the plumber to connect the two.

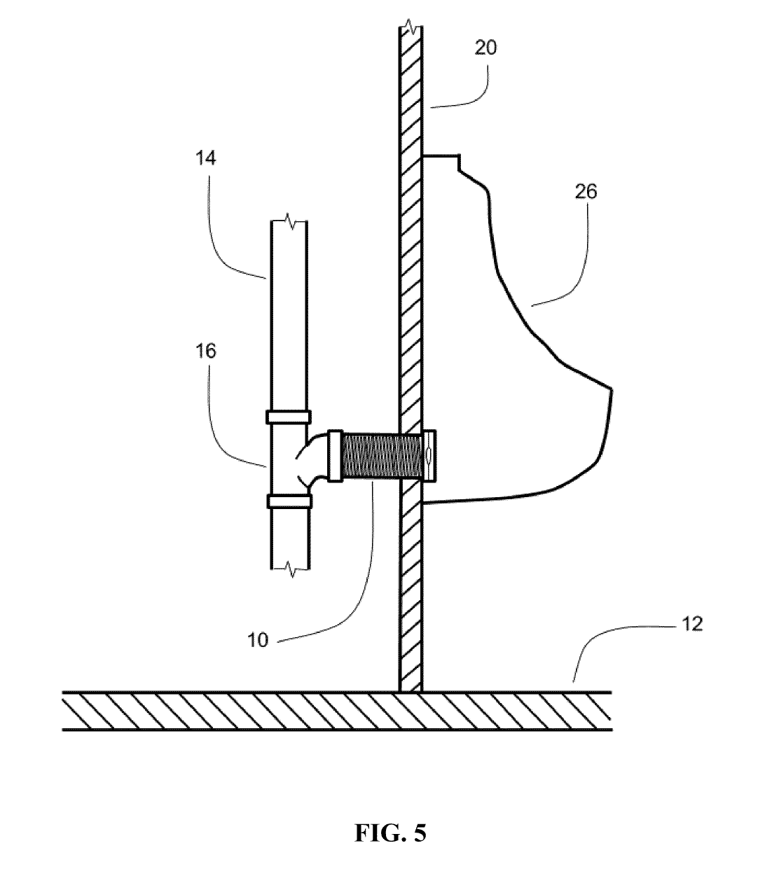

To eliminate the amount of time taken by the plumber the Flanged Nipple may be used by the plumber to replace both nipple 22 and flange 24 shown in FIG. 4. FIG. 5 shows Flanged Nipple 10 having replaced both nipple 22 and flange 24 shown in FIG. 4. Since Flanged Nipple 10 has straight male threads it may be cut at any point along its length in order to properly bridge the distance between “T” fitting 16 and urinal 26. In addition the pitch of Flanged Nipple 10 thread is slightly smaller than the pitch on the thread on “T” fitting 16 allowing Flanged Nipple 10 to travel the necessary distance into “T” fitting 16 needed in order to meet the requirements of the ANSI standard B1.20.1. Moreover he small pitch causes the threads on Flanged Nipple 10 to engage the threads on “T” fitting 16 ever more tightly the further Flanged Nipple 10 is screwed into “T” fitting 16 thus forming a watertight seal between “T” fitting 16 and Flanged Nipple 10.

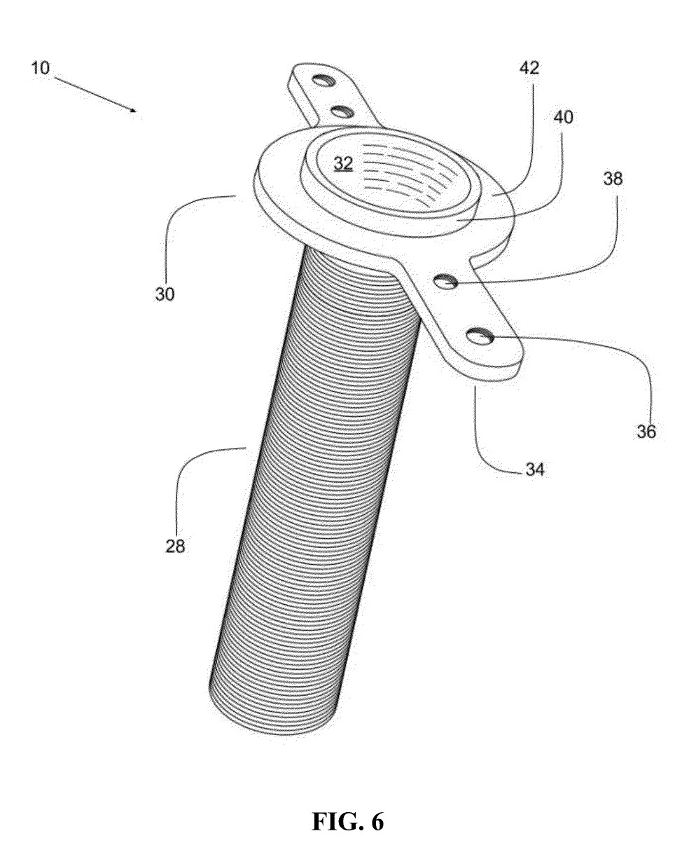

FIG. 6 is a perspective view of the preferred embodiment of flanged. Nipple 10 showing tubular portion 28 with flange portion 30 positioned proximate to and outwardly about first opening 32 of tubular portion 28. Flange portion 30 is comprised of lip 42 about tubular portion 28 with two arms 34 extending radially from first opening 32 and opposite from one another. FIG. 6 shows the arms in the preferred embodiment containing two pairs of mounting points, 36 and 38. Other embodiments may have shorter arms with a single pair of mounting points or longer arms with three or more mounting points. First opening 32 permits the passage of effluent (e.g. water, sewage, etc.) from urinal 26 to “T” fitting 16 through tubular portion 28. Collar 40 is to be of such height so as to secure the position of a resilient gasket placed on flange portion 30 and so form a watertight seal between Flanged Nipple 10 and urinal 26. Other embodiments of Flanged Nipple 10 may integrate a resilient gasket further reduce the number of discrete parts needed to mount urinal 26. In the preferred embodiment Flanged Nipple 10 is fabricated from copper but other metallic materials and alloys or plastics that are resistant to urinal corrosion may be used.

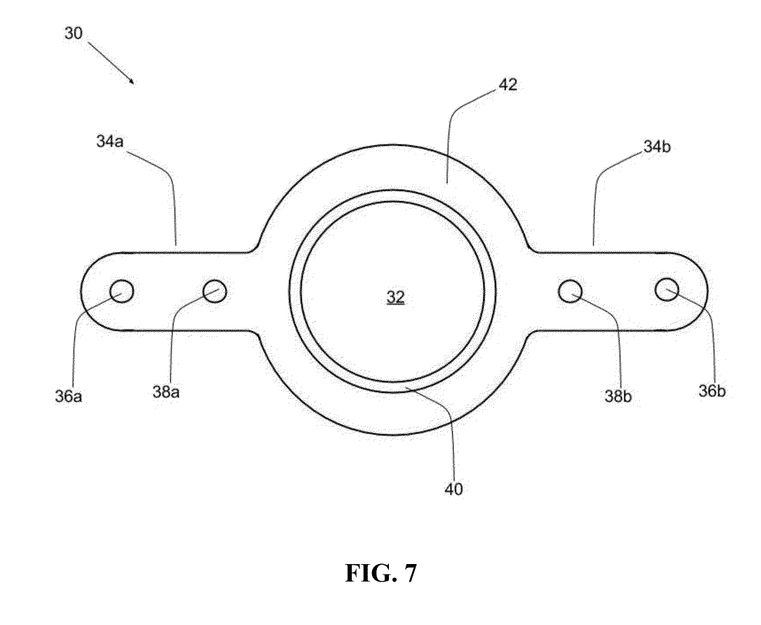

FIG. 7 shows the front of flange portion 30 of Flanged Nipple 10 in its preferred embodiment. Flange portion 30 positioned proximate to and outwardly about first opening 32 of tubular portion 28. Flange portion 30 is comprised of lip 42 about tubular portion 28 with two arms 34 extending radially from first opening 32 and opposite from one another. Although arms 34 are shown with two pairs of mounting points, 36 and 38, arms 34 may be shortened to have only a single pair of mounting points or lengthened to have more than two pairs of mounting points. A resilient gasket may be placed on the surface of lip 42 and is to some degree secured by the friction fit of collar 40. Other embodiments of Flanged Nipple 10 may secure the resilient gasket by an adhesive.

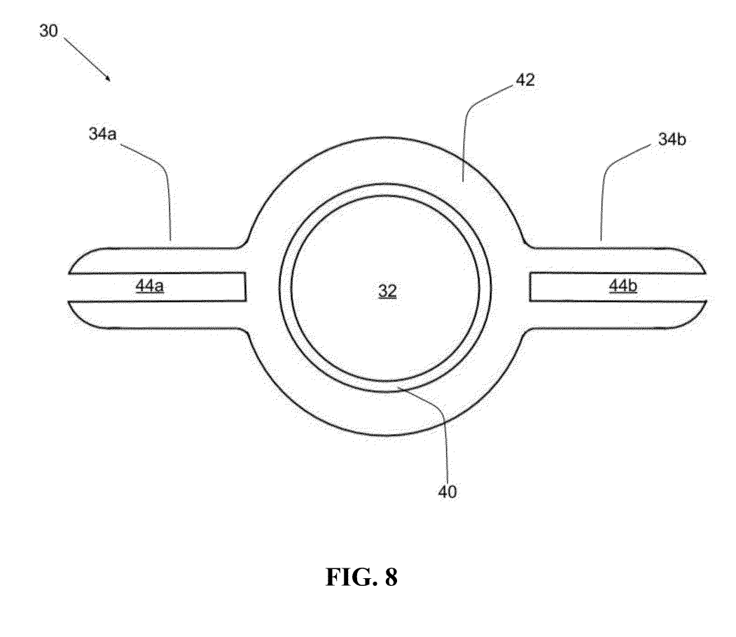

FIG. 8 shows the front view of flange portion 30 of Flanged Nipple 10 in an alternative embodiment. Flange portion 30 positioned proximate to and outwardly about first opening 32 of tubular portion 28. Flange portion 30 is comprised of lip 42 about tubular portion 28 with two arms 34 extending radially from first opening 32 and opposite from one another. Arms 34 have channels 44 that traverses along the entire length of arms 34 and are of such width so that mounting bolts that pass through the urinal mate with receiving nuts and washers positioned along the back side of arms 34. A resilient gasket may be placed on the surface of lip 42 and is to some degree secured by the friction fit of collar 40. Other embodiments of Flanged Nipple 10 may secure the resilient gasket by an adhesive.

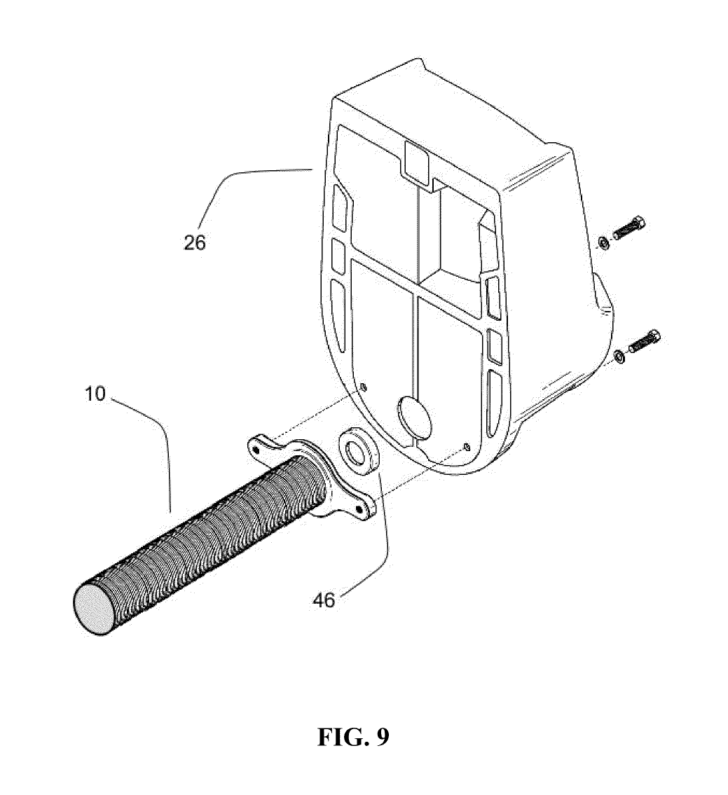

FIG. 9 shows an exploded assembly view of Flanged Nipple 10, resilient gasket 46, urinal 26, and related components. In this particular embodiment Flanged Nipple 10 is shown with only one pair arms 34 radiating from first opening 32 and opposite from one another with each arm having one pair of mounting points. Mounting bolts 48 pass through urinal 26 and are threaded into mounting points in Flanged Nipple 10. Between Flanged Nipple 10 and urinal 26 resilient gasket 46 is used to provide a watertight seal.

In yet another embodiment the nipple and flange portions of the Flanged Nipple may be fabricated as distinct parts from one another. This embodiment may be useful in situations where more than one type of urinal is to be installed and the flanged portion of he Flanged Nipple needs to be change for each type of urinal. The nipple portion in this embodiment will continue to use the straight threading at a pitch slightly less than the pitch of the receiving thread as does the preferred embodiment uses. The flanged portion in this embodiment will have two openings. A first opening to be in fluid communications with a urinal and a second opening to be in fluid communications with the nipple. The flanged portion second opening will have straight female threading at a pitch slightly larger than the pitch of the threading outside of the nipple portion so that when the nipple is screwed in a watertight seal is formed. The flanged portion first opening will have a lip about the opening that is configured to receive a resilient gasket and one or more arms extending radially outwards from the center of the flange. The arms will have a structure to receive urinal mounting bolts.

The construction and arrangement of the elements of the Flanged Nipple as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and assemblies disclosed herein may be constructed from any of a wide variety of materials that provide sufficient strength or durability, in any of a wide variety of colors, textures, and combinations.

What is claimed is:

1. A flanged nipple for coupling a urinal to a waste line, comprising:
a tubular portion having
a first opening configured to be in fluid communication with a urinal,
a second opening configured to be in fluid communication with a waste line,
a smooth inner surface to facilitate the passage of effluent from said urinal to said waste line, and
a threaded outer surface of pitch smaller than the pitch of threaded portion of said waste line receiving said second opening;
a flange portion proximate to and outwardly about said first opening having
a lip configured to receive a resilient gasket, and
one or more arms extending radially from the center of said flange where each arm having a structure configured to receive a fastener for coupling said flanged nipple to the urinal

2. The flanged nipple of claim 1, wherein when said flanged nipple is in an installed position, said flanged nipple is configured to compress said resilient gasket against the urinal.

3. The flanged nipple of claim 1, wherein said resilient gasket is integrally formed with said lip to provide a molded-in gasket.

4. The flanged nipple of claim 1, wherein said tubular portion and said flange portion are fabricated as a single piece.

5. The flanged nipple of claim 1 being made of a metallic material that is resistant to corrosion caused by human urine.

6. The flanged nipple of claim 1 being made of a plastic material that is resistant to corrosion caused by human urine.

7. The flanged nipple of claim 1, wherein said arms are limited to two diametrically opposite arms.

8. The flanged nipple of claim 1, wherein said structure being one or more screw holes positioned along said arm to receive one or more bolts supporting said urinal.

9. The flanged nipple of claim 1, wherein said structure being a channel traversing lengthwise within said arm to allow one or more bolts supporting said urinal to pass through said arm and secured by a receiving nut.

10. The flanged nipple of claim 1, wherein the ratio of the pitch of said threaded outer surface to the pitch of said threaded portion of waste line is between 0.90 and 0.95.

11. A flanged nipple for coupling a urinal to a waste line, comprising:
a tubular portion having
a first opening configured to be in fluid communication with a flange,
a second opening configured to be in fluid communication with a waste line,
a smooth inner surface to facilitate the passage of effluent from said flange to said waste line, and
a threaded outer surface of smaller pitch than the pitch of threaded portion of said waste line receiving said second opening; and
said flange having
a first opening configured to be in fluid communication with said urinal,
a second opening is opposite to and in fluid communication with first opening and is configured to receive said tubular portion first opening,
one or more arms extending radially from the center of the flange where each arm having a structure configured to receive a fastener for coupling said flanged nipple to the urinal, and
a lip proximate to and outwardly about said first opening being configured to receive a resilient gasket.

12. The flanged nipple of claim 11, wherein when said flanged nipple is in an installed position, said flanged nipple is configured to compress said resilient gasket against the urinal.

13. The flanged nipple of claim 11, wherein said resilient gasket is integrally formed with said lip to provide a molded-in gasket.

14. The flanged nipple of claim 11 being made of a metallic material that is resistant to corrosion caused by human urine.

15. The flanged nipple of claim 11 being made of a plastic material that is resistant to corrosion caused by human urine.

16. The flanged nipple of claim 11, wherein said arms are limited to two diametrically opposite arms.

17. The flanged nipple of claim 11, wherein said structure being one or more screw holes positioned along said arm to receive one or more bolts supporting said urinal.

18. The flanged nipple of claim 11, wherein said structure being a channel traversing lengthwise within said arm to allow one or more bolts supporting said urinal to pass through said arm and secured by a receiving nut.

19. The flanged nipple of claim 11, wherein the ratio of the pitch of said threaded outer surface to the pitch of said threaded portion of waste line is between 0.90 and 0.95.
